(19) United States
(12) Patent Application Publication
(10) Pub. No.: US 2019/0104884 A1
(43) Pub. Date: Apr. 11, 2019

(54) COOKING PAN WITH DRAINING SURFACE

(71) Applicant: Finex Cast Iron Works, Inc., Portland, OR (US)

(72) Inventors: Iranpour Khormaei, Vancouver, WA (US); Michael Whitehead, The Dalles, OR (US); Patrick A. Scranton, Vancouver, WA (US)

(21) Appl. No.: 16/158,054

(22) Filed: Oct. 11, 2018

Related U.S. Application Data
(60) Provisional application No. 62/571,126, filed on Oct. 11, 2017.

(51) Int. Cl. A47J 37/06; A47J 37/10

(52) U.S. Cl. CPC A47J 37/06; A47J 37/10

(57) ABSTRACT

Examples are disclosed that relate to cooking pans. In one example, a cooking pan comprises a dome-shaped draining surface that slopes downwardly from a center portion toward a first side and an opposite second side, and slopes downwardly from the center portion toward a first end and an opposite second end; and a plurality of ribs extending upwardly from the draining surface, wherein each of the ribs comprises a raised cooking surface at a distal end.

### CROSS-REFERENCE TO RELATED APPLICATIONS

This application claims the benefit of U.S. Provisional Patent Application No. 62/571,126, filed Oct. 11, 2017, and entitled “SLOPED DRAINING COOKWARE SURFACE”, the complete contents of which are hereby incorporated herein by reference for all purposes.

### BACKGROUND

A cooking pan may utilize a number of ribs as raised cooking surfaces on which food may be grilled. While grilling, spaces between the ribs may collect substantial amounts of meat fat, oily drippings, excess marinade, etc. Sloped or ramped ribs may drain such liquids. However, such ramped cooking surfaces cause uneven cooking and may enable some foods to slide off the cook surface.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to cooking pans. In one example, a cooking pan comprises a dome-shaped draining surface that slopes downwardly from a center portion toward a first side and an opposite second side, and slopes downwardly from the center portion toward a first end and an opposite second end. The cooking pan also comprises a plurality of ribs extending upwardly from the draining surface, wherein each of the ribs comprises a raised cooking surface at a distal end.

### BRIEF DESCRIPTION OF THE DRAWINGS

FIG. 1 shows a perspective view of an example cooking pan according to examples of the present disclosure.

FIG. 2 shows a top view of the cooking pan illustrated in the example of FIG. 1.

FIG. 3 illustrates a side view of a first side of the cooking pan illustrated in the example of FIG. 1.

FIG. 4 shows a side view of a second side opposite the first side of the cooking pan illustrated in the example of FIG. 1.

FIG. 5 illustrates an end view of a first end of the cooking pan illustrated in the example of FIG. 1.

FIG. 6 shows an end view of a second end opposite the first end of the cooking pan illustrated in the example of FIG. 1.

FIG. 7 illustrates a bottom view of the cooking pan illustrated in the example of FIG. 1.

FIG. 8 shows a cross section view of the cooking pan illustrated in the example of FIG. 1 taken along line 4-4 of FIG. 1.

FIG. 9 shows another cross-section view of the cooking pan illustrated in the example of FIG. 1 taken along line 5-5 of FIG. 1.

### DETAILED DESCRIPTION

A cooking pan may utilize a number of ribs as raised cooking surfaces on which food may be grilled. While grilling, spaces between the ribs may collect substantial amounts of liquids such as meat fat, oily drippings, excess marinade, etc. The accumulation of such substances can lead to frying of the food rather than grilling and may result in higher fat content per serving.

Some grill pans use sloped or ramped ribs that drain fats from food while grilling. However, configurations that use ramped ribs force users to cook on a slope. In these designs, foods may shift or slide down the ramped ribs, requiring the user to reposition the food. In some examples the food may slide entirely off the cooking surface. Further, the sloped cooking surfaces in these designs create a variable distance from the heat source to the food, which in turn can lead to uneven heating and cooking of the food.

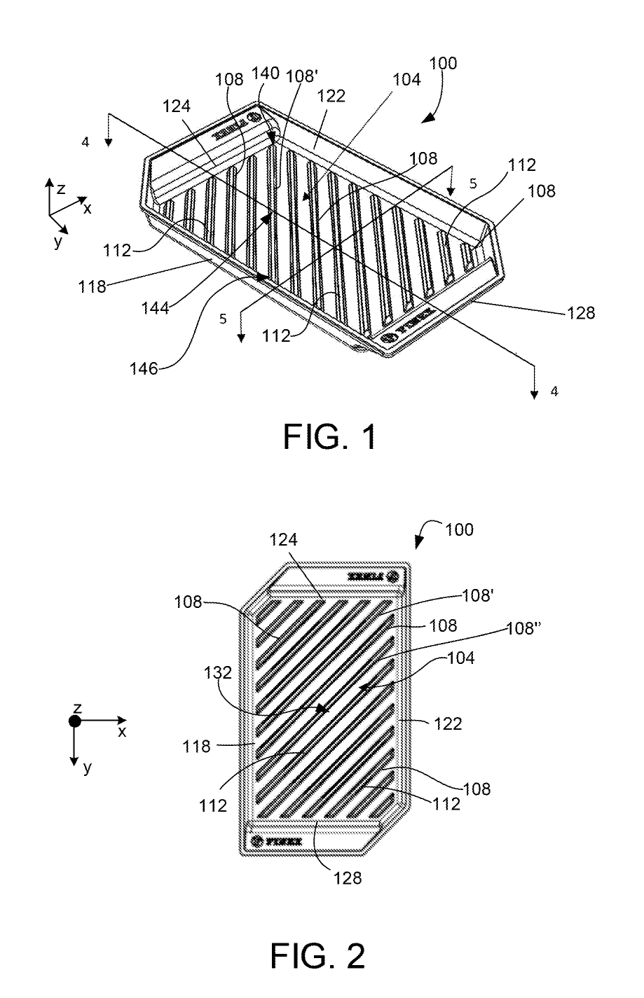

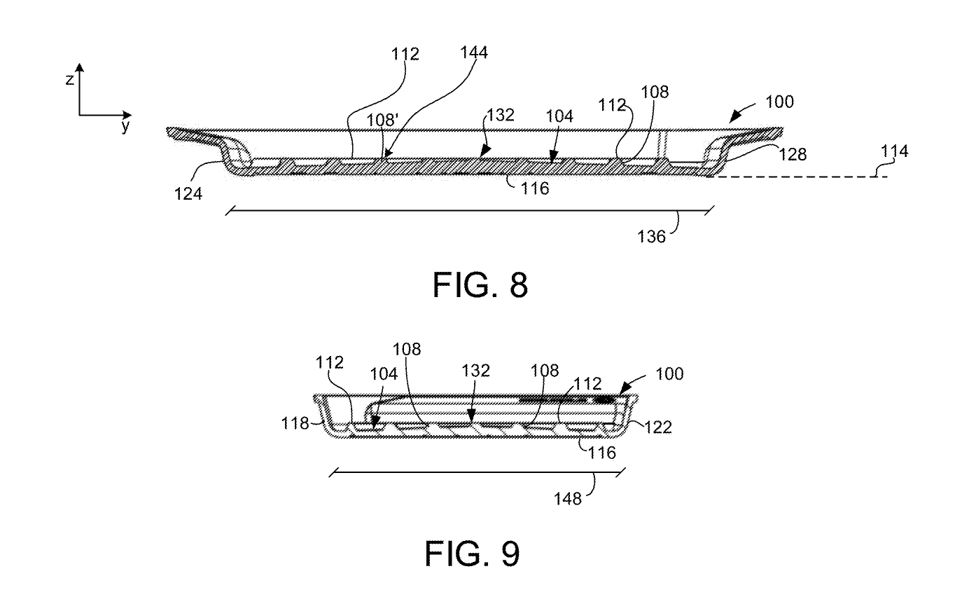

Accordingly, examples are disclosed that relate to cooking pans that address one or more of above-described aspects. With reference now to FIG. 1, in one example a cooking pan 100 comprises a dome-shaped draining surface 104 and a plurality of diagonally-oriented grill ribs 108. Each of the plurality of grill ribs 108 extends upwardly in a z-axis direction away from the draining surface 104 of the pan 100. In some examples and with reference also to FIG. 8, each of the grill ribs 108 may extend upwardly in a direction generally perpendicular to a plane 114 formed by a bottom surface 116 of the pan 100.

With reference also to FIGS. 8 and 9, each of the grill ribs 108 further comprises a raised cooking surface 112 configured to contact the food being cooked. Each cooking surface 112 is located at a distal end of the rib with respect to the draining surface 104. Opposite to each cooking surface 112, a proximal end of each of the grill ribs 108 is adjacent to the draining surface 104. In this manner, the dome-shaped draining surface 104 is positioned beneath the raised cooking surfaces 112.

Accordingly, this configuration channels liquids and other drippings draining from food atop the cooking surfaces 112 to the sides and ends of the pan 100 via the sloped surfaces of the dome-shaped draining surface 104. Advantageously, in this manner the dome-shaped draining surface 104 operates to transfer the liquids away from the food. Additionally, the domed shape of the draining surface 104 efficiently distributes liquids and drippings to different sides and ends of the pan 100 based upon the location of the food in the pan. Advantageously, this configuration further helps prevent the accumulation of liquids/drippings in one location of the pan. Additionally, and as described in more detail below, all of the raised cooking surfaces 112 of the plurality of ribs 108 may be substantially coplanar to thereby provide uniform and level cooking surfaces on which the food is supported.

The draining surface 104 may be domed across an entire width and length of the pan 100, creating a dome-shaped surface underneath the raised cooking surfaces 112. For example, and as described in more detail below with reference to FIGS. 8-9, the dome-shaped draining surface 104 slopes downwardly from a center portion 132 of the pan 100 toward a first side 118 and an opposite second side 122 of the pan 100, and slopes downwardly from the center portion toward a first end 124 and an opposite second end 128 of the pan 100.

Accordingly, with reference again to FIG. 2, the dome-shaped draining surface may be highest, or closest to the raised cooking surfaces 112, near a center portion 132 of the pan 100. The dome-shaped draining surface may be lowest, or farthest from the raised cooking surfaces 112, near or adjacent to one of the first side 118, the second side 122, the first end 124, or the second end 128. Advantageously with this configuration, liquids may collect on the lowest portions of the draining surface, away from the food being cooked.

It follows that this configuration may provide more effective drainage for liquids and other drippings, such as fat from meat or water from vegetables. In this manner, the present configuration may thereby promote even and uniform cooking of foods, and avoid unintended cooking/frying by reducing contact between the food and liquids drained from the food. Additionally, this configuration allows for food preparation that may reduce the per-serving fat content of food by removing the fat from the food cooking area.

In the example illustrated in FIGS. 1 and 2, the cooking pan 100 has a generally rectangular shape with a chamfered portion at each end. In this example and with reference also to FIGS. 8 and 9, the first side 118 and the second side 122 of the cooking pan 100 have a side length 136, and the first end 124 and the second end 128 have an end width 148 that is less than the side length. Further, in the example of FIGS. 1 and 2, a first portion of the plurality of diagonal grill ribs 108 extends from adjacent the second end 128 to adjacent the second side 122 of the pan 100, a second portion of the ribs extends from adjacent the first side 118 to adjacent the second side 122, and a third portion of the ribs extends from adjacent the first side 118 to adjacent the first end 124.

In other examples, the cooking pan 100 may have a round or square form factor, or any other suitable configuration that utilizes a dome-shaped draining surface as described herein. The grill ribs may also be oriented in any suitable manner.

Additionally, and in one potential advantage of the present disclosure, the grill ribs 108 are configured to contact the food at a consistent and uniform level. For example, and as illustrated in FIGS. 1 and 2, the cooking surface 112 of each of the grill ribs 108 may comprise a substantially flat planar surface. In the example of FIGS. 1 and 2 and with reference also to FIGS. 8 and 9, the raised cooking surfaces 112 are substantially coplanar, such that each of the raised cooking surfaces 112 lies on a common plane. Further, the common plane may be substantially parallel to or level with respect to a bottom surface 116 of the cooking pan 100. This may prevent any sliding or shifting of food during the cooking process. Additionally, such coplanar cooking surfaces support the food at a uniform distance from the heat source underlying the pan.

It will also be appreciated that each cooking surface 112 or any one of the cooking surfaces 112 may comprise any other suitable shape. For example, the raised cooking surfaces 112 may be rounded or substantially pointed. In such examples, an uppermost portion of each raised cooking surface 112 may lie on a common plane such that the cooking surfaces may contact the food in a uniform and level manner. For example, the common plane may be tangent to each cooking surface of a plurality of rounded cooking surfaces and parallel to the bottom surface 116 of the pan 100.

The pan 100 may also comprise one or more additional spaces or channels. For example, one or more of the grill ribs 108 may not contact the sides of the pan 100. In this manner, liquids may drain from between the grill ribs 108 via the space between the grill ribs 108 and the sides and/or ends of the pan 100.

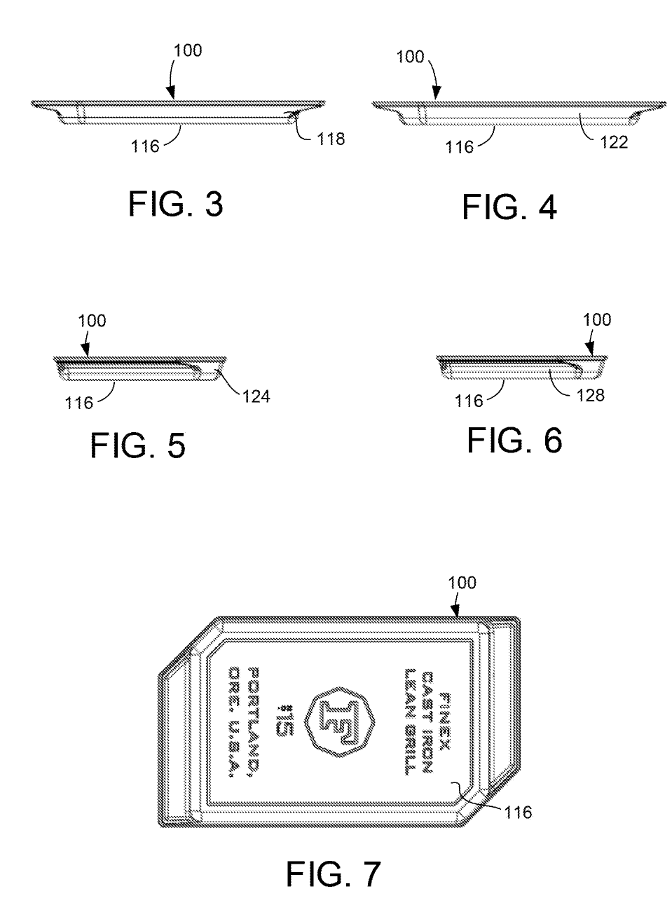

With reference now to FIGS. 3-6, various side and end views of the cooking pan 100 are illustrated. FIG. 3 shows a side view of the first side 118 of the cooking pan 100. FIG. 4 shows another side view of the cooking pan 100, illustrating the second side 122 opposite the first side 118 of the pan. FIG. 5 shows an end view of the first end 124 of the cooking pan 100 of FIG. 1. FIG. 6 shows another end view of the second end 128 of the pan opposite to the first end 124.

With reference also to FIG. 7, the cooking pan 100 may comprise a substantially planar bottom surface 116. The bottom surface 116 may be configured to contact or face a heat source. Additionally, it will be appreciated from the illustrations of the cooking pan 100 in FIGS. 1-7 that the plane formed by the bottom surface 116 may be parallel to the common plane of each of the planar raised cooking surfaces 112. In this manner, the cooking surfaces 112 may be level with respect to the bottom surface 116 of the cooking pan 100. Accordingly, when the cooking pan is placed on a substantially level surface, the food in the pan also may rest on a level cooking surface.

With reference now to FIG. 8, a cross-section of the cooking pan 100 is illustrated along line 4-4 of FIG. 1. As shown in FIG. 8, the dome-shaped draining surface 104 slopes downwardly from the center portion 132 of the pan 100 toward the first end 124 of the pan 100 and toward the second end 128 opposite the first end 124. In this manner, liquids that fall onto the draining surface 104 may flow away from the center portion 132.

FIG. 9 illustrates another cross-section view of the cooking pan 100 along line 5-5 of FIG. 1. As illustrated in FIG. 9, the dome-shaped draining surface 104 also slopes downwardly from the center portion 132 of the pan 100 toward the first side 118 of the pan 100 and toward the second side 122 opposite the first side 118.

As illustrated by both FIGS. 8 and 9, the draining surface 104 is domed from the center across an end-to-end length 136 and across a side-to-side width 148 of the pan 100. Additionally, one or more of the ribs 108 may have a differing shape and/or differing dimensions from other ribs such that the raised cooking surfaces 112 are substantially coplanar and parallel to the bottom surface 116 of the pan 100.

For example, each cooking surface 112 of a rib 108 may have a height, defined by a distance from the draining surface 104 at the proximal end of the rib 108 to the cooking surface 112 at the distal end of the rib 108. To create the coplanar cooking surfaces 112 above the domed draining surface 104, for each rib 108 of at least a subset of the ribs, the height of the cooking surface may increase as a distance from the center portion 132 of the draining surface increases. In other words, the height of the rib above the domed draining surface 104 may change across the length of the rib to compensate for the curvature of the domed surface below the rib, and to thereby create a flat and planar cooking surface 112 across the distal end of the rib.

In this manner, and with reference to FIGS. 1, 8 and 9, for a given rib 108 of the subset of ribs, the height of the rib may be tallest adjacent to the sides 118, 122 and ends 124, 128 of the cooking pan 100, and shortest in the center portion 132 of the pan. In this configuration, for each rib of the subset of ribs, a height of the raised cooking surface 112 above the dome-shaped draining surface 104 changes from a first end of the rib to a middle portion of the rib. Similarly, for each of these ribs the height of the raised cooking surface 112 above the dome-shaped draining surface 104 changes from the middle portion of the rib to the second end of the rib opposite to the first end.

In the example shown in FIG. 8, and with reference to one rib 108′ of the subset of ribs 108, this figure shows the height of the raised cooking surface 112 above the draining surface 104 changing from one end of this rib 108′ to another as the draining surface 104 slopes away from the center portion 132. With reference also to FIG. 1, the rib 108′ extends from a beginning portion 140 adjacent to the first end 124 diagonally across the pan 100 to an ending portion 146 adjacent to the first side 118 of the pan. In this example, the raised cooking surface 112 of the rib 108′ has a greater height above the dome-shaped draining surface 104 at the beginning portion 140 than in a middle portion 144 that is closer to the center portion 132 of the cooking pan 100. Likewise, the height decreases from the middle portion 144 of the rib 108′ to the ending portion 146 at the first side 118. For purposes of the present disclosure, the above-described characteristic in which the height of a rib 108 changes across the length of the rib is referred to as the “variable height” characteristic.

In the examples shown in FIGS. 1-9 and with reference to FIG. 2, cooking pan 100 utilizes 15 ribs 108, with 7 ribs arranged on either side of a central rib 108″. In one example, each of the center rib 108″ and the 4 ribs on either side of the central rib have the variable-height characteristic described above, while the outermost 3 ribs adjacent to the two ends 124 and 128 do not have this characteristic and instead have substantially the same height across the length of the rib. In other examples, fewer or greater numbers of the ribs 108 may have the variable-height characteristic. Additionally, while the example of cooking pan 100 described above utilizes 15 ribs 108, it will also be appreciated that any other suitable number of ribs may be utilized.

In other examples, aspects of the present disclosure may be utilized in a removable apparatus that includes the characteristics and configurations described above. The removable apparatus may be added to an existing cooking pan to provide the drainage, uniform cooking and other features described herein.

It will be understood that the configurations and/or approaches described herein are exemplary in nature, and that these specific embodiments or examples are not to be considered in a limiting sense, because numerous variations are possible. The subject matter of the present disclosure includes all novel and non-obvious combinations and sub-combinations of the various processes, systems and configurations, and other features, functions, acts, and/or properties disclosed herein, as well as any and all equivalents thereof.

1. A cooking pan, comprising:
a dome-shaped draining surface that slopes downwardly from a center portion toward a first side and an opposite second side, and slopes downwardly from the center portion toward a first end and an opposite second end; and
a plurality of ribs extending upwardly from the draining surface, wherein each of the ribs comprises a raised cooking surface at a distal end.

2. The cooking pan of claim 1, wherein the raised cooking surfaces of the plurality of ribs are substantially coplanar.

3. The cooking pan of claim 2, wherein each of the plurality of raised cooking surfaces is substantially planar.

4. The cooking pan of claim 3, further comprising a planar bottom surface configured to face a heat source, wherein the planar bottom surface is parallel to each of the substantially planar raised cooking surfaces.

5. The cooking pan of claim 1, wherein for at least a subset of ribs of the plurality of ribs, a height of the raised cooking surface above the draining surface increases as a distance from the center portion of the draining surface increases.

6. The cooking pan of claim 1, wherein for at least a subset of ribs of the plurality of ribs, a height of the raised cooking surface above the draining surface changes from a first end of the rib to a middle portion of the rib.

7. The cooking pan of claim 6, wherein for each rib of the subset of ribs, a height of the raised cooking surface above the draining surface changes from the middle portion of the rib to a second end of the rib opposite to the first end.

8. The cooking pan of claim 1, wherein the first side and the opposite second side have a side length, and the first end and the opposite second end have an end width that is less than the side length.

9. The cooking pan of claim 1, wherein a first portion of the plurality of ribs extend from adjacent the second end to adjacent the second side, and a second portion of the plurality of ribs extend from adjacent the first side to adjacent the second side.
